(19) United States
(12) Patent Application Publication
(10) Pub. No.: US 2026/0078252 A1
(43) Pub. Date: Mar. 19, 2026

(54) Underwater Curable Thermoset Composition

(71) Applicant: Zephyros, Inc., Romeo, MI (US)

(72) Inventors: Hamid Mortazavian, Romeo, MI (US); Michael Czaplicki, Romeo, MI (US); Donald Paquet, Romeo, MI (US); Kevin Cox, Romeo, MI (US)

(21) Appl. No.: 18/857,080

(22) PCT Filed: Apr. 25, 2023
(86) PCT No.: PCT/US2023/019729

§ 371 Date: Oct. 15, 2024

Related U.S. Application Data
(60) Provisional application No. 63/336,365, filed on Apr. 29, 2022.

(51) Int. Cl. C08L 63/04; C04B 28/04; C08G 59/38; C08G 59/40; C08K 3/26; C08K 3/32; C08K 3/36

(52) U.S. Cl. CPC C08L 63/04; C04B 28/04; C08G 59/38; C08G 59/4071; C08K 3/32; C08K 3/36; C08K 2003/265; C08K 2003/329; C08K 2201/005; C08L 2205/035; C08L 2207/53

(57) ABSTRACT

A two-part system comprising a first component including one or more epoxy resins and an epoxy functional material having a functionality of greater than 4 and viscosity at 25° C. of less than 850 cps and a second component including one or more phosphate esters, wherein upon mixing the first component with the second component at room temperature, a composition is formed having a cured underwater lap shear at peak stress of at least 7 MPa in accordance with ASTM D1002-10.

### FIELD

The present teachings relate generally to an ambient temperature activated thermosetting composition adapted for curing underwater. It comprises a first component including at least one constituent with epoxide functionality, and a second component including an acidic curing agent.

### BACKGROUND

Metals and cementitious materials degrade due to extended exposure to wet or underwater environments. Underwater and wet conditions are considered very difficult working environment for these materials. The need to maintain and/or reinforce these materials after being exposed to these conditions is common. Current two component underwater repair solutions have certain drawbacks. Usually, these existing two-part solutions are very viscous and difficult to mix and apply. Typically, they are supplied as two separate parts and not in a single cartridge. They also tend to be very slow reacting systems that can take hours to days to complete the reaction, or they require additional stimuli such as ultraviolet (UV) light or heat to rapidly activate and cure. Another drawback of the existing materials is that they often are suggested for only limited substrate types and certain conditions and are not recommended as a more universal repair option for underwater repair applications.

The present teachings solve one or more of the problems addressed above by providing two component compositions that are fast cure bonding solutions. They can be easily applied using cartridges or existing two component dispensing equipment if desired. The compositions described herein bond to a wide variety of substrates including but not limited to concrete, aluminum, stainless steel, wood, and plastics.

The teachings herein facilitate simplifying the process of underwater repair by minimizing the steps and providing a solution that applies to a wider variety of substrates.

The present teachings relate to a rapid cure composition that is adapted to withstand underwater conditions, comprising at least one epoxide functional constituent in side-A and at least one acid in side-B. These two-component room-temperature activated materials may be cured in air. Typically, the presence of water may lead to hydrolysis of the curatives and thus may prevent them from curing (and possibly foaming). To minimize the impact of water on the cure characteristics of the composition, three main strategies have been utilized: repelling the water with low energy materials, generating enough heat from exothermic reactions that would evaporate or push the water from the interface even if for a short period of time, and engaging with and absorbing the water from the interface between the substrate and the material composition.

This underwater repair solution provided herein has significant tensile and compressive strength, making it ideal for difficult environments such as support columns, driveway drains, pool decks, and the like. This underwater two-component material maintains the structural integrity of the substrate, stops leakage, and reduces cost of and time to repair. Another advantage of the two-component underwater solution is no need (or minimized need) of surface preparation prior to application.

The compositions described herein may or may not foam. If the material foams, it is possible that the volumetric expansion of the foam may be from 1% to 20%, though higher expansion percentages may be desirable. Foaming may be preferred as can help to infuse and fill small irregularities and cracks in a cavity.

International PCT Publication Nos. WO 2020/101732, WO 2020/205355, WO 2020/206346, and WO 2020/198139 illustrate the use of phosphoric acid and phosphate esters for cure-in-place compositions. These compositions are typically employed for a wide range of room-temperature activated systems, such as rigid structural foams, cavity filling, gaskets, and sealants. The benefits of such compositions may include the ability to adhere to a variety of substrates, the inclusion of low volatility organic compounds (VOC's), not being sensitive to the dispensing temperature, not being sensitive to the exact mixing ratio of a two-part system, the ability to tune physical and mechanical properties, or any combination thereof. The focus of the present teachings is thermosetting compositions that are adapted for cure in underwater conditions and thus could repair many structures in wet, damp, and/or underwater conditions.

### SUMMARY

The present teachings provide for a two-part system comprising a first component including one or more epoxy resins; and an epoxy functional material (compound) having an epoxy functionality of greater than 4 and viscosity at 25° C. of less than 850 cps determined according to ASTM D445. A second component is included comprising one or more phosphate esters. Upon mixing the first component with the second component at room temperature, a composition is formed having a cured underwater lap shear at peak stress of at least 7 MPa and/or comprising or essentially consisting of 40 to 85 wt.-% of the one or more epoxy resins relative to the weight of the first component; preferably wherein the one or more epoxy resins comprise or essentially consist of liquid epoxy resin, epoxy phenol novolac resin, epoxy resin dissolved in xylene, or combinations thereof; 0.5 to 10 wt.-% of the epoxy functional material relative to the weight of the first component; preferably wherein the epoxy functional material comprises or essentially consists of epoxidized linseed oil; 50 to 90 wt.-% of the one or more phosphate esters relative to the weight of the second component; and one or more additives in both the first and second component.

The cured underwater lap shear at peak stress according to the invention is determined according to ASTM D1002-10 at 23° C.

For the purpose of the specification, the terms “two-part system” and “two-component system” are used interchangeably. The same applies in this context to the individual terms “part”, “component” and “side”, e.g. “A-side” and “B-side” Unless expressly stated otherwise, the “first component” corresponds to the “first part” and “A-side”, respectively. Unless expressly stated otherwise, the “second component” corresponds to the “second part” and “B-side”, respectively.

Upon mixing the first component and second component, the composition may cure at a temperature of about 0° C. to about 50° C. The first component may include a cement. The first component may include silicone prepolymer.

The one or more phosphate esters may include a phosphate ester derived from cashew nutshell liquid (CNSL). The one or more phosphate esters may include a phosphate ester derived from 2-ethylhexyl glycidyl ether. The one or more phosphate esters includes a phosphate ester may be derived from phenyl glycidyl ether. The one or more phosphate esters may include a phosphate ester derived from an epoxidized para-tertiary butyl phenol. The one or more phosphate esters may include a nonyl phenol ethoxylated phosphate ester.

The epoxy functional material may be an epoxidized linseed oil. The composition may include one or more additives selected from a core-shell polymer, metal carbonate, minerals, reinforcing fiber, hydrophobic silica, a monomer, tabular alumina, or any combination thereof. The composition may include a metal carbonate which may be calcium carbonate present in an amount from about 0.01% to about 10% by weight. The composition may include an ultrafine calcium carbonate (about 1 micron average particle size), a fine calcium carbonate (about 4 micron average particle size), a medium fine calcium carbonate (about 22 micron average particle size), or any combination thereof.

One or both of the first and second component may include Wollastonite. One or both of the first and second component may include fumed silica. The second component may include P₂O₅. The second component may include one or more of tabular alumina, reinforcing fiber, hydrophobic silica, minerals, a monomer, phosphoric acid, polyphosphoric acid, or any combination thereof.

The one or more epoxy resins and epoxy functional material may include one or more liquid epoxy resins, one or more epoxy phenol novolac resins, one or more aliphatic multifunctional epoxy resins, one or more phenoxy resins, one or more silane modified epoxy resins, or any combination thereof. The composition may include one or more epoxy phenol novolac resins with a functionality from about 2 to about 3; an epoxy phenol novolac resin with a functionality from about 3 to about 4; or both. The composition may include one or more epoxy phenol novolac resins present in an amount from about 20% to about 50% by weight. The composition may include one or more silicone prepolymers present in an amount of at least 0.5% by weight.

The composition may cure at a temperature of from about 10° C. to about 50° C. The composition may cure at a temperature of about 15° C. to about 25° C. The composition may cure in water. The two-part system may be substantially free of curing agents, latent curing accelerators, or both (other than the phosphate esters).

The second component may include P₂O₅, polyphosphoric acid, or some combination thereof in an amount of from about 1% to about 15% by weight, preferably from about 3% to about 10% by weight, even more preferably from about 5% to about 8% by weight relative to the total weight of the second component.

The first component may include the epoxy functional material in an amount of from about 0.1% to about 15% by weight, preferably from about 0.4% to about 10% by weight, even more preferably from about 1% to about 7% by weight relative to the total weight of the first component.

The first component may include epoxidized linseed oil in an amount of from about 0.1% to about 15% by weight, preferably from about 0.4% to about 10% by weight, even more preferably from about 1% to about 7% by weight relative to the total weight of the first component.

The first component may include Portland cement in an amount of from about 0.1% to about 10% by weight, preferably from about 0.5% to about 8% by weight, even more preferably from about 0.9% to about 5% by weight relative to the total weight of the first component.

The first component may include an epoxy resin dissolved in xylene in an amount of from about 0.5% to about 30% by weight, preferably from about 2% to about 20% by weight, even more preferably from about 5% to about 15% by weight relative to the total weight of the first component.

The resulting composition may comprise the first component and second component in a ratio of from about 5 parts by volume first component to about 1 part by volume second component. The resulting composition may comprise the first component and second component in a ratio of from about 4 parts by volume first component to about 1 part by volume second component. The resulting composition may comprise the first component and second component in a ratio of from about 3 parts by volume first component to about 1 part by volume second component.

The teachings herein are further directed to a two-part system comprising liquid epoxy resin and epoxy resin dissolved xylene in a first component, an epoxy functional material comprising epoxidized linseed oil in the first component, one or more phosphate esters in a second component, and P₂O₅, polyphosphoric acid, or some combination thereof in the second component.

### BRIEF DESCRIPTION OF THE DRAWINGS

FIG. 1 shows comparative test data of formulations shown at Table 1.

FIG. 2A and FIG. 2B show comparative test data of formulations shown at Table 1.

FIG. 3 shows comparative test data of formulations shown at Table 1.

### DETAILED DESCRIPTION

The present teachings meet one or more of the above needs by the improved compositions and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing date of U.S. Provisional Application No. 63/336,365, filed on Apr. 29, 2022. The contents of that application are hereby incorporated by reference herein in their entirety for all purposes.

The present teachings relate to two-component underwater curing compositions that are capable of fast bonding. They can be easily applied using cartridges or other common two component dispensing equipment. They bond to a wide range of substrates including but not limited to concrete, aluminum, stainless steel, wood, and plastics. The nature of the materials may shorten and simplify the process of underwater repair by minimizing the steps and operations required for existing systems.

In general, the materials that are specified to be applied in air are unsuitable for underwater dispensing. It is thus desirable to create compositions that overcome this problem. The compositions herein have been discovered to: (1) reduce surface energy in order to produce a more hydrophobic material and repel the water from interface; (2) engage with water by reacting with and absorbing the water and thereby reducing the presence of water at the interface of the composition and the substrate; and (3) generating sufficient exotherm to evaporate some water at the interface for a short time.

Each one of these strategies may have certain limitations when used on its own. For example, if the formulation is made of many hydrophobic materials with low surface energy, the material might completely repel the water but wetting and subsequent bonding to many substrates could be difficult. On the other hand, if the material only absorbs and reacts with water, it may have poor long term water resistance. Work to this point indicates that combining two or more mechanisms, may be beneficial to obtain an attractive property balance.

Underwater construction and repair is typically more difficult and more expensive than under dry conditions. Material options are limited and there is need for a durable material that could be applied easily and cures quickly.

Another advantage of the current invention is that there is no need (or minimized need) for surface preparation prior to application. Most existing materials require careful surface preparation to ensure that the substrates are sufficiently clean prior to application; therefore, most technologies are not good candidates for underwater repair applications, where surface preparation is difficult, perhaps impossible.

The composition of the present teachings may be a two-part composition (“two-part system”). The two-part system may comprise an A-side (“first component”) and a B-side (“second component”). The A-side and the B-side may be mixed to form a mixed composition. The mixed composition may cure to form a reaction product. The reaction product may be completely cured (i.e., undergoing no further cross-linking reactions). Curing may initiate after mixing the A-side and the B-side. Curing may initiate generally immediately upon mixing the A-side and the B-side. Curing may be delayed for a time after mixing the A-side and the B-side. The two-part system may be free of latent curing agents, curing accelerators, or both.

The two-part system may be mixed at a temperature of about 0° C. to 50° C. Curing of the two-part system may activate at room temperature. Volume expansion, if desired, may increase by increasing the temperature of the mixed composition and/or the temperature of the A-side and/or the B-side at the time of mixing. Ambient water temperature may not affect foaming rate as much as the temperature of the two-part system at the time of dispensing.

The two-part system may form a thermoset material.

The A-side may include an epoxidized linseed oil. Epoxidized linseed oil is a very low viscosity component having a high functionality (a functionality of approximately 7) to promote rapid curing. Epoxidized linseed oil is generally used as lubricant in paints and coatings. The combination of high functionality and low viscosity make the epoxidized linseed oil a very fast reacting and highly crosslinking material when cured using certain acidic curative compositions. This material is highly hydrophobic and tends to repel moisture and water from a substrate. The reaction of epoxidized linseed oil in the A-side with certain acidic materials in the B-side can be highly exothermic. The epoxidized linseed oil component contributes mechanisms for making suitable underwater repair solutions. It assists in physically repulsing water due to its hydrophobicity and to evaporation of the water due to a highly exothermic reaction. A couple of non-limiting examples of suitable epoxidized linseed oils may include Vikoflex 7190 from Cargill or Epoxol 9-5 from ACS Technical Products.

The A-side may include one or more di- or multi-functional silicone pre-polymers with epoxide terminal end groups. One non-limiting example is Silmer EPC Di-50 which is a siloxane pre-polymer with cycloaliphatic epoxide groups. Silmer EPC Di-50 is a difunctional reactive polymer which can lower the stiffness of the cured composition. This molecule is a very hydrophobic material and can react with acidic materials in B-side relatively quickly. The highly hydrophobic nature of the molecule helps by repelling the water and moisture away and making an improved bond with the substrate.

The A-side may include a type of water curable cementitious material such as cement. Cement is an inorganic material usually based on calcium silicate. Presence of cement in the formulation may help to absorb water both initially and as water that diffuses into the bulk material. The near immediate absorption may assist to enable interaction of the organic portion of the composition with the bonding interface. Cement cures more slowly compared to the rest of the formulated composition. When cured, cement is not a water soluble and thus has good underwater durability. Portland cement is one non-limiting example of the cement that could be used in the formulation.

The A-side may include other materials that are capable of absorbing and/or reacting with water. Examples include garden gypsum (calcium sulfate) and calcium oxide.

The A-side may include one or more additional epoxide functional material, which may include epoxy resins. The additional epoxy resins may include multifunctional aromatic epoxy resins, multifunctional aliphatic epoxy resins, silane modified epoxy resins, epoxy/elastomer adducts, epoxidized natural products such as soybean oil, or any combination thereof.

The two-part system may include one or more multifunctional aromatic and/or aliphatic epoxy resins. The multifunctional aromatic and/or aliphatic epoxy resins may increase the crosslink density of the reaction product, improve mechanical properties of the reaction product, improve chemical resistance of the reaction product, increase reaction speed, reduce the viscosity of the two-part system and/or mixed composition, improve the cell structure quality of a foamed reaction product, or any combination thereof. The functionality of the multifunctional aromatic and/or aliphatic resin may be about 2.1 or more, 3 or more, or even 4 or more. The functionality of the multifunctional aromatic and/or aliphatic resin may be about 8 or less, 7 or less, or even 6 or less.

The two-part system may include one or more epoxy novolac resins. The epoxy novolac resin may be liquid or solid at room temperature. The two-part system may include one or more liquid epoxy novolac resins, one or more solid epoxy novolac resins, or both. The epoxy novolac resin may have a functionality of about 2.1 to 6.5. The epoxy novolac resin may function to improve crosslink density, increase reaction speed, improve glass transition temperature, improve mechanical properties, improve chemical resistance, improve moisture resistance, or any combination thereof of the reaction product. The epoxy novolac resins are hydrophobic molecules that react very quickly and exotherm when reacting with acid groups.

The A-side may include one or more epoxy-based materials (i.e., one or more epoxy resins). The one or more epoxy resins may be any conventional dimeric, oligomeric, or polymeric epoxy resin. The one or more epoxy resins may contain at least one epoxide functional group (i.e., monofunctional) or may contain more than one epoxide functional group (i.e., multifunctional). The one or more epoxy resins may contain one or more epoxide functional group, two or more epoxide functional groups, three or more epoxide functional groups, or even four or more epoxide functional groups. The one or more epoxy resins may be modified epoxy resins (e.g., silane modified, elastomer modified, and the like). The one or more epoxy resins may be aliphatic, cycloaliphatic, aromatic, or the like, or any combination thereof. The one or more epoxy resins may be supplied as a solid (e.g., as pellets, chunks, pieces, or the like, or any combination thereof) or a liquid (e.g., a liquid epoxy resin). As used herein, unless otherwise stated, an epoxy resin is a solid if it is solid at a temperature of 23° C. and is a liquid resin if it a liquid at a temperature of 23° C. The one or more epoxy resins may include one or more liquid epoxy resins, one or more flexible epoxy resins, one or more epoxy phenol novolac resins, one or more aliphatic multifunctional epoxy resins, one or more reactive diluents, one or more phenoxy resins, one or more silane modified epoxy resins, or any combination thereof.

The two-part system may include one or more liquid epoxy resins. The liquid epoxy resin may function as a base for the epoxy resin component. The liquid epoxy resin may be a reaction product of epichlorohydrin (hereinafter, “EPH”) and any conventional bisphenol. The liquid epoxy resin may be a reaction product of EPH and bisphenol A (hereinafter, “BPA”), bisphenol F (hereinafter, “BPF”), or both. The liquid epoxy resin may have an epoxide equivalent weight (hereinafter “EEW”) from about 160 g/equivalent to about 192 g/equivalent as measured according to ASTM D1652-97. The liquid epoxy resin may have an epoxide percentage from about 20 to about 25. The liquid epoxy resin may have a viscosity from about 2,000 cP to about 14,000 cP at 25° C. as measured according to ASTM D445. An example of a suitable BPA-based liquid epoxy resin may be D.E.R.™ 331, commercially available from The Olin Corporation (Clayton, MO). An example of a suitable BPF-based liquid epoxy resin may be YDF-170 commercially available from Kukdo Chemical (South Korea).

The liquid epoxy resin may be present as a part of the A-side. The liquid epoxy resin may be present in an amount of from about 4% to about 70% by weight of the A-side. The liquid epoxy resin may be present in an amount of from about 6% to about 10% by weight of the A-side. The liquid epoxy resin may be present in an amount of about 8% by weight of the A-side.

The two-part system may include one or more flexible epoxy resins. The one or more flexible epoxy resins may function to reduce the compression modulus, increase strain to failure, decrease time to recover, decrease the degree of cross-linking density, increase impact resistance, improve adhesion, improve peel resistance, or any combination thereof, of the reaction product. To the extent the resulting composition is foamed, the one or more flexible epoxy resins may improve the gas entrapment capability of the two-part system impart by acting as a viscosity modifier. The one or more flexible epoxy resin may be a di-functional glycidyl ether epoxy resin, an unmodified BPA-based epoxy resin, a multifunctional epoxidized polybutadiene resin, or any combination thereof. The one or more flexible epoxy resins may have an EEW of about 260 to about 500 as measured according to ASTM D1652-97. The one or more flexible epoxy resins may have a viscosity of about 700 cP to about 25,000 cP at 25° C. as measured according to ASTM D445. Examples of suitable flexible epoxy resins may include NC-514 (commercially available from Cardolite Corporation, Monmouth Junction NJ), Araldite® PY 4122 (commercially available from Huntsman Advanced Materials, Inc., Salt Lake City, UT), Poly bd® 605E (commercially available from Cray Valley, Exton, PA), or any combination thereof.

The one or more flexible epoxy resins may be present in the A-side. The one or more flexible epoxy resins may be present in an amount from about 0.5% to about 40% by weight of the A-side. The one or more flexible epoxy resins may be present in an amount from about 35% to about 45% by weight of the A-side. The one or more flexible epoxy resins may be present in an amount of about 39% by weight of the A-side. The one or more flexible epoxy resins may include a di-functional glycidyl ether epoxy resin in the amount of from about 10% to about 18% by weight of the A-side, an unmodified BPA-based epoxy resin in an amount from about 8% to about 16% by weight of the A-side, and a multifunctional epoxidized polybutadiene resin in an amount from about 8% to about 16% by weight of the A-side. The one or more flexible epoxy resins may include a di-functional glycidyl ether epoxy resin in the amount of about 5% to 20% by weight of the A-side, an unmodified BPA-based epoxy resin in an amount of about 5% to about 20% by weight of the A-side, and a multifunctional epoxidized polybutadiene resin in an amount of about 5% to about 20% by weight of the A-side. The two-component system may include a di-functional glycidyl ether epoxy resin, a difunctional epoxy derived from cardanol, and a multifunctional epoxidized polybutadiene resin, respectfully in a ratio of about 1:1:1. The two-component system may include a di-functional glycidyl ether epoxy resin, a difunctional epoxy derived from cardanol, and a multifunctional epoxidized polybutadiene resin. The aforementioned resins may be present in a ratio of about 1:0.8:0.8, respectively. The two-component system may include a di-functional glycidyl ether epoxy resin, a difunctional epoxy derived from cardanol, and a multifunctional epoxidized polybutadiene resin. The aforementioned resins may be present in a ratio of about 1:0.9:0.9, respectfully.

The two-part system described herein may also include one or more epoxy phenol novolac resins. The one or more epoxy phenol novolac resins may function to impart chemical resistance, solvent resistance, temperature resistance, or any combination thereof, to the reaction product. The one or more epoxy phenol novolac resins may be present as a part of the A-side. The one or more epoxy phenol novolac resins may have an EEW from about 165 g/equivalent to about 183 g/equivalent as measured according to ASTM D1652-97. The one or more epoxy phenol novolac resins may have an average epoxy functionality from about 2.1 to about 6.5. The one or more epoxy phenol novolac resins may have a viscosity from about 18,000 cP to about 30,000 cP at 25° C. as measured according to ASTM D445. Examples of suitable epoxy phenol novolac resins may be those sold under the trade names Epalloy® 8250 (formaldehyde, oligomeric reaction products with 1-chloro-2,3-epoxypropane and phenol; 2.6 functionality) and Epalloy® 8330 (Poly[(phenyl glycidyl ether)-co-formaldehyde]; 3.6 functionality), commercially available from Huntsman.

The one or more epoxy phenol novolac resin may be present in an amount from about 10% to about 60% by weight of the A-side. The one or more epoxy phenol novolac resins may be present in an amount of about 35% to about 45% by weight of the first component or A-side. The one or more epoxy phenol novolac resins may be present in an amount of about 38% to about 42% by weight of the A-side. The one or more epoxy phenol novolac resins may be present in an amount of about 42% by weight of the A-side. The one or more epoxy phenol novolac resins may include an about 3.6 functional epoxy phenol novolac resin present in an amount of from about 0.1% to about 50% by weight of the A-side and an about 6.5 functional epoxy novolac resin present in an amount of from about 22% to about 32% by weight of the A-side. The one or more epoxy phenol novolac resins may include an about 3.6 functional epoxy phenol novolac resin present in an amount of about 15% by weight of the A-side and an about 6.5 functional epoxy novolac resin present in an amount of about 28% by weight of the A-side. The two-part system may include an about 3.6 functional epoxy phenol novolac resin and an about 6.5 functional epoxy phenol novolac resin at a ratio of about 1:2 to about 1:3.

The two-part system may include one or more aliphatic multifunctional epoxy resins. The one or more aliphatic multifunctional epoxy resins may function to increase the degree of cross-linking of the reaction product, increase the chemical resistance of the reaction product, or both. The one or more aliphatic multifunctional epoxy resins may include an epoxidized sorbitol. The one or more aliphatic multifunctional epoxy resins may have an EEW from about 160 g/equivalent to about 195 g/equivalent as measured according to ASTM D1652-97. The one or more aliphatic multifunctional epoxy resins may have a viscosity from about 4,000 cP to about 18,000 cP at 25° C. as measured according to ASTM D445. Examples of suitable aliphatic multifunctional epoxy resins may be those sold under the trade names ERISYS® GE-60 and ERISYS® GE-61, commercially available from Huntsman.

The one or more aliphatic multifunctional epoxy resins may be present as a part of the A-side. The one or more aliphatic multifunctional epoxy resins may be present in an amount from about 4% to about 60% by weight of the A-side. The one or more aliphatic multifunctional epoxy resins may be present in an amount from about 10% to about 22% by weight of the A-side. The one or more aliphatic multifunctional epoxy resins may be present in an amount of about 20% by weight of the A-side. The one or more aliphatic multifunctional epoxy resins may be present in an amount of about 13% by weight of the A-side.

The two-part system may include one or more reactive diluents. The one or more reactive diluents may function to reduce the overall viscosity of the two-part system, in order to modify the dispensing process or the flow of the two-part system on a workpiece after dispensing, increase the degree of cross-linking of the reaction product, for multi-functional diluents or both. The one or more reactive diluents may be polymeric, whereby the reactive diluent may increase the flexibility of the reaction product; the one or more reactive diluents may be multifunctional, whereby the reactive diluent may promote increased crosslinking and impart chemical resistance on the reaction product; or both. The one or more reactive diluents may include a polyglycol diglycidyl ether, a trimethylolethane triglycidyl either, or both. The one or more reactive diluents may have an EEW from about 150 g/equivalent to about 170 g/equivalent as measured according to ASTM D1652-97. The one or more reactive diluents may have a viscosity of about 200 cP to about 300 cP at 25° C. as measured according to ASTM D445. An example of a suitable reactive diluents may be those sold under the trade names ERISYS® GE-31 and ERISYS® GE-24, commercially available from Huntsman.

The one or more reactive diluents may be present in an amount from about 5% to about 20% by weight of the A-side. The one or more reactive diluents may be present in an amount from about 8% to about 16% by weight of the A-side. The one or more reactive diluents may be present in an amount from about 10% to about 14% by weight of the A-side. The one or more reactive diluents may be present in an amount of about 13% by weight of the A-side. The one or more reactive diluents may include a polyglycol diglycidyl ether present in an amount from about 2% to about 6% by weight of the A-side, and a trimethylolethane triglycidyl present in an amount from about 6% to about 14% of the A-side. The one or more reactive diluents may include a polyglycol diglycidyl ether present in an amount of about 4% by weight of the A-side, and a trimethylolethane triglycidyl present in an amount of about 9% of the A-side. The two-part system may include a polyglycol diglycidyl ether and a trimethylolethane triglycidyl ether respectively at a ratio of about 1:2 to about 1:3.

The two-part system may include one or more phenoxy resins (i.e., polyhydroxy ether). The one or more phenoxy resins may function to impart improved adhesion, corrosion resistance, heat resistance, or any combination thereof to the reaction product. The one or more phenoxy resins may be derived from the reaction of BPA and EPH. The one or more phenoxy resins may have terminal hydroxyl groups as well as hydroxyl groups in every repeating polymeric unit. The one or more phenoxy resins when dissolved in a solvent may have an EEW from about 202 g/equivalent to about 214 g/equivalent as measured according to ASTM D1652-97. The one or more phenoxy resins may have a viscosity from about 20,000 cP to about 50,000 cP at 25° C. as measured according to ASTM D445. An example of a suitable phenoxy resin may be Phenoxy LER-HB commercially available from Huntsman.

The one or more phenoxy resins may be present in an amount from about 1% to about 20% by weight of the A-side. The one or more phenoxy resins may be present in an amount from about 7% to about 12% by weight of the A-side. The one or more phenoxy resins may be present in an amount of about 10% by weight of the A-side.

The two-part system may include one or more toughening agents. The one or more toughening agents may function to distribute energy within the reaction product (i.e., increase impact resistance). The one or more toughening agents may contribute to an increased T-Peel strength. The one or more toughening agents may comprise thermoplastics, thermosets or thermosettables, elastomers, the like, or any combination thereof. The one or more toughening agents may include elastomers (including elastomer containing materials), core-shell polymers (which may include but are not limited to elastomers), or both.

The core-shell polymers, if present, may comprise a first polymeric material (i.e., core material) and a second polymeric material (i.e., shell material). The first polymeric material may be entirely encapsulated by the second polymeric material. The core-shell polymer may include a first polymeric material in the amount of about 30% or more, 50% or more, or even 70% or more by weight. The first polymeric material, the second polymeric material, or both may comprise one, two, three, or even more than three polymers that are combined together, reacted together (e.g., sequentially polymerized), or both, or may be part of separate or the same core-shell polymer systems. An example of a suitable core-shell polymer may be that sold under the trade name Kane Ace® MX-267 and MX-257 commercially available from Kaneka North America LLC (Pasadena, TX).

The core-shell polymers may be present in an amount from about 1% to about 25% by weight of the A-side, B-side, or both the A-side and B-side in combination (e.g., if present in the amount of 10% by weight, then it may be present in an amount of 5% in the A-side and 5% in the B-side). The core-shell polymer may be present in an amount from about 5% to about 20% by weight of the A-side, B-side, or both the A-side and B-side in combination. The core-shell polymer may be present in an amount of about 5% by weight of the A-side, B-side, or both the A-side and B-side in combination. The core-shell polymer may be present in an amount of about 17% by weight of the A-side, B-side, or both the A-side and B-side in combination.

The two-part system may comprise one or more core-shell particulate polymers. The core-shell particulate polymer may function to improve the fracture toughness impact resistance, peel resistance, and ductility of the reaction product. Epoxy resin formulations are usually known for applications that require rigidity and high temperature resistance. Unmodified standard epoxies tend to be brittle. There are different strategies to reduce the epoxy brittleness. Often, tougheners such as core-shell polymers particles are used to reduce the brittleness and improve the ductility of the reaction product without affecting the temperature resistance significantly as they are discrete particles that do not become part of the continuous phase.

The core-shell particulate polymer may be present in the A-side, B-side, or both. The core-shell particulate polymer may be present in an amount of about 5% or more, 10% or more, or even 15% or more, by weight of the A-side or B-side. The core-shell particulate polymer may be present in an amount of about 35% or less, 30% or less, or even 25% or less, by weight of the A-side or B-side.

The core-shell particulate polymer may be pre dispersed into an epoxy resin. The core-shell particulate polymer may be dispersed in a bisphenol A-based epoxy resin. The epoxy resin mixture may be a liquid epoxy resin. The epoxy resin may have a viscosity, measured at 50° C., of about 16,000 cP to about 20,000 cP, more preferably 17,000 cP to 19,000 cP, or even more preferably about 18,000 cP, according to ASTM D445-21. The core-shell particulate polymer may be present in the epoxy resin in an amount of about 30% to 45%, more preferably 35% to 40%, or even more preferably about 37%. The core-shell particulate polymer may have a median particle size of about 100 nm to 300 nm, or even about 200 nm. The core-shell particulate polymer may comprise polybutadiene. Non-limiting examples of suitable core-shell particulate polymers may include Kane Ace MX-257 and MX-267, which are specific products where core-shell is already distributed in epoxy resin, commercially available from Kaneka Corporation. Alternatively, powdered core/shell materials may be used in the composition as well such as E-950 available form Arkema corporation.

The two-part system may include one or more silane modified epoxy resins. The silane modified epoxy resin may function to impart improved adhesion of the reaction product. The adhesion may be to glass, metal, or both. The silane groups may form covalent bonds with epoxy resins and inorganic substrates. The silane modified epoxy resin may be present in the A-side. The silane modified epoxy resin may be present in an amount of about 0.5% or more, 1% or more, 2% or more, or even 3% or more, by weight of the A-side. The silane modified epoxy resin may be present in an amount of about 10% or less, 9% or less, 8% or less, or even 7% or less, by weight of the A-side. The one or more silane modified epoxy resins may be present in an amount of about 1% to about 7% by weight of the A-side. The one or more silane modified epoxy resins may be present in an amount of about 2% to about 6% by weight of the A-side. The one or more silane modified epoxy resins may be present in an amount of about 4% by weight of the A-side.

The silane modified epoxy resin may have an epoxy equivalent weight of about 170 g/eq to 240 g/eq, more preferably about 180 g/eq to 230 g/eq, or even more preferably about 190 g/eq to 220 g/eq, according to ASTM D1652-11. The silane modified epoxy resin may have a viscosity, measured at 25° C., of about 7,000 cP to 17,000 cP, more preferably about 8,000 cP to 16,000 cP, or even more preferably about 9,000 cP to 15,000 cP. A non-limiting example of a suitable silane modified epoxy resin may include Epokukdo KSR 177, commercially available from Kukdo Chemical Co., Ltd.

The silane modified epoxy may be a linear-difunctional silicone pre-polymer terminated with a cyclic epoxide (e.g., a pre-polymer with cycloaliphatic epoxide group). Another suitable material would be a silicone pre-polymer with cycloaliphatic epoxide groups. An example of one such material is available under the trade name Silmer EPC Di-50, available from Siltech Corporation in Ontario, Canada.

The two-part system may include a metal carbonate material. The metal carbonate material may be calcium carbonate. The calcium carbonate may have a median particle size of from about 1 to about 50 microns. The calcium carbonate may be a medium particle size. For example, the median particle size of the medium calcium carbonate may be about 22 microns. An example of a suitable medium fine calcium carbonate may be Hubercarb® Q200, commercially available from Huber Engineered Materials, Atlanta, GA. The calcium carbonate may be a fine particle size. For example, the median particle size of the fine calcium carbonate may be about 4 microns. An example of a suitable fine calcium carbonate may be Hubercarb® Q4, commercially available from Huber Engineered Materials, Atlanta, GA. The calcium carbonate may be ultra-fine particle size. For example, the median particle size of the ultra-fine calcium carbonate may be about 1 micron. An example of a suitable ultra-fine calcium carbonate may be Hubercarb® Q1, commercially available from Huber Engineered Materials, Atlanta, GA. The two-part system may include medium fine calcium carbonate, fine calcium carbonate, ultra-fine calcium carbonate, or any combination thereof.

Where the two-part system includes metal carbonate in the A-side, average functionality of the B-side may be partially reduced when combined with the A-side in the mixed composition. This may be due to reaction of the acid of the B-side with the metal carbonates of the A-side to cause foaming. The A-side may include components with increased functionality to compensate for a reduced functionality of the B-side. The A-side may be formulated with increased functionality by using reactive ingredients with functionality greater than 2 such as aliphatic multifunctional epoxy resins.

The B-side may comprise one or more acids. The acid may be liquid at room temperature. Room temperature, as referred to herein, may mean a temperature of between about 20° C. and 25° C. The acid may comprise phosphate ester, phosphoric acid, citric acid, acetic acid, or any acid that is stable when mixed with phosphoric acid or phosphate esters. The acid may comprise at least phosphate ester and optionally phosphoric acid, liquid polyphosphoric acid, citric acid, acetic acid, or any combination thereof.

The working time of the mixed composition may be tuned by the selection of the acid. Employing phosphate esters instead of phosphoric acid may delay the curing reaction, due to their higher pH, lower functionality, higher viscosity, or any combination thereof. The functionality and pH of phosphate esters may be selected to tune the working time.

The B-side may include phosphorous pentoxide (P₂O₅) which is an anhydride of phosphoric acid. This white crystalline solid could react with water or moisture, generate excessive heat, and turn to phosphoric acid. The reaction is very rapid and highly exothermic. The phosphoric acid then could react with the epoxide groups or metal carbonates from the A-side. This material helps with two of the mechanisms that we are interested in. Absorbing and reacting with water and also generating heat to evaporate water from the substrate.

The B-side may comprise one or more phosphate esters, phosphate ester precursors, or both. The one or more phosphate esters may be pre-reacted. The B-side may comprise one or more phosphate ester precursors that may be combined with phosphoric acid prior to combination with the A-side.

The B-side may include additional phosphoric acid. The additional phosphoric acid may include ortho-phosphoric acid, polyphosphoric acid, or both. The additional phosphoric acid may increase the crosslink density and shorten the reaction time. Reaction speed of the pre-reacted phosphate esters may be increased by the addition of the additional phosphoric acid in the B-side. The additional phosphoric acid may increase foaming of the mixed composition.

The A-side may comprise one or more epoxy resins, one or more additives, one or more monomers, or any combination thereof. The one or more epoxy resins may include one or more liquid epoxy resins, one or more flexible epoxy resins, one or more epoxy phenol novolac resins, one or more aliphatic multifunctional epoxy resins, one or more reactive diluents, one or more phenoxy resins, one or more silane modified epoxy resins, one or more monomers, or any combination thereof. The one or more additives may include one or more toughening agents (e.g., core-shell polymer), metal carbonates, minerals, reinforcing fibers or other reinforcing particulates, hydrophobic silica, tabular alumina, or any combination thereof.

The B-side may comprise one or more phosphate esters, phosphoric acid, one or more additives, one or more monomers, or any combination thereof. The one or more phosphate esters may include a first phosphate ester, a second phosphate ester, a third phosphate ester, or any combination thereof. The one or more additives may include one or more toughening agents (e.g., core-shell polymer), minerals, reinforcing fibers or other reinforcing particulates, hydrophobic silica, tabular alumina, or any combination thereof.

The one or more phosphate esters may be one or more customized phosphate esters. The one or more customized phosphate esters may be produced by the reaction of phosphoric acid and various alcohols. The one or more customized phosphate esters may be produced by the reaction of phosphoric acid and an epoxide group of a phosphate ester precursor (i.e., component not yet reacted with phosphoric acid). The one or more customized phosphate esters may be produced by the reaction of phosphoric acid with the glycidyl ether of cashew nutshell liquid (CNSL) such as that sold under the trade name Cardolite® LITE 2513HP, commercially available from Cardolite Corporation, Monmouth Junction NJ. The one or more customized phosphate esters may be produced by the reaction of phosphoric acid with a phenyl glycidyl ether such as that sold under the trade name ERISYS® GE-13, commercially available from Huntsman. The one or more customized phosphate esters may be produced by the reaction of phosphoric acid with 2-ethylhexyl glycidyl ether such as that sold under the trade name ERISYS® GE-6, commercially available from Huntsman. The one or more customized phosphate esters may be produced by the reaction of phosphoric acid with an epoxidized para-tertiary butyl phenol such as that sold under the trade name ERISYS® GE-11, commercially available from Huntsman.

The one or more phosphate esters may be one or more commercial phosphate esters. The one or more commercial phosphate esters, when swapped into the B-side in place of a customized phosphate ester may result in a curable composition that is slower reacting and foaming presumably due to a lower amount of free phosphoric acid. Reacting and foaming of the one or more commercial phosphate esters may be improved (i.e., sped up) by the addition of phosphoric acid in the B-side. The one or more commercial phosphate esters may have a pH of about 1 to 3 in aqueous solution. The one or more commercial phosphate esters may have a viscosity of about 32,500 cP to about 42,500 cP at 25° C. as measured according to ASTM D445. The one or more commercial phosphate esters may be a nonyl phenol ethoxylated phosphate ester. Examples of suitable commercial phosphate esters may be those sold under the trade names of Dextrol™ OC-110, Dextrol OC-40, and Strodex MO-100 commercially available from Ashland, Inc. (Covington, KY).

The commercial phosphate esters may be present in the B-side. The one or more commercial phosphate esters may be present in an amount of about 6% to about 18% by weight of the B-side. The one or more commercial phosphate esters may be present in an amount of about 8% to about 16% by weight of the B-side. The one or more commercial phosphate esters may be present in an amount of about 10% to about 14% by weight of the B-side. The one or more commercial phosphate esters may be present in an amount of about 12% by weight of the B-side.

The one or more phosphate esters may be produced by a reaction of a range of stoichiometric ratios of phosphate ester precursors to phosphoric acid. The one or more phosphate esters may be produced by a reaction of about 0.7:1 phosphate ester precursor to phosphoric acid to about 1:0.7 phosphate ester precursor to phosphoric acid. The one or more phosphate esters may be produced by a reaction of about 0.8:1 phosphate ester precursor to phosphoric acid to about 1:0.8 phosphate ester precursor to phosphoric acid. The one or more phosphate esters may be produced by a reaction of about 0.9:1 phosphate ester precursor to phosphoric acid to about 1:0.9 phosphate ester precursor to phosphoric acid. The one or more phosphate esters may be produced by a reaction of about 1:1 phosphate ester precursor to phosphoric acid. The one or more phosphate esters may be produced by a reaction of about 0.8:1 phosphate ester precursor to phosphoric acid.

The one or more phosphate esters may be selected from mono-esters, di-esters, or tri-esters as shown below:

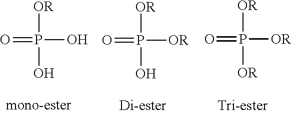

The one or more phosphate esters may be obtained from the reaction of epoxide groups with phosphoric acid as depicted below:

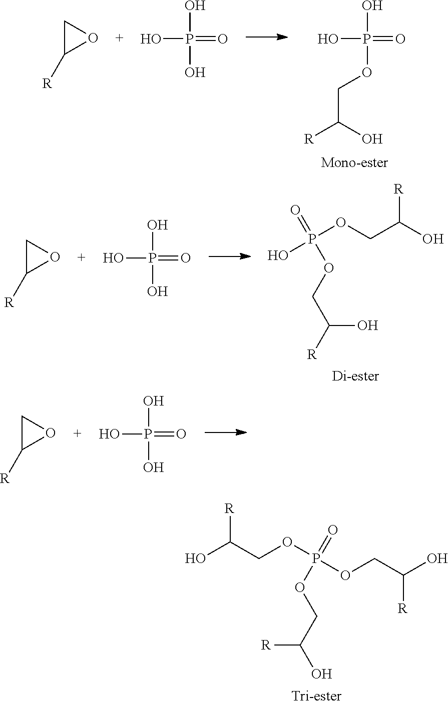

The B-side may comprise one or more phosphate esters, one or more phosphate ester precursors, or both. The B-side may comprise one or more phosphate ester precursors that may be combined with phosphoric acid prior to combination with the A-side. The B-side may comprise one or more phosphate esters that are pre-reacted (i.e., the epoxide and phosphate reaction) before addition to the B-side.

The first phosphate ester may be a reaction product of phosphoric acid with 2-ethylhexyl glycidyl ether. The second phosphate ester may be a reaction product of an epoxidized para-tertiary butyl phenol, a reaction product of a glycidyl ether of cashew nutshell liquid (CNSL), a nonyl phenol ethoxylated phosphate ester, or a combination thereof. The third phosphate ester may be a reaction product of phosphoric acid with a phenyl glycidyl ether. The B-side may include the first phosphate ester, the second phosphate ester, the third phosphate ester, or a combination thereof.

The first phosphate ester may be present in an amount from about 1% to about 70% by weight of the B-side. The first phosphate ester may be present in an amount from about 5% to about 60% by weight of the B-side. The first phosphate ester may be present in an amount from about 10% to about 30% by weight of the B-side. The second phosphate ester, if present, may be present in an amount from about 1% to about 80% by weight of the B-side. The second phosphate ester may be present in an amount from about 3% to about 50% by weight of the B-side. The second phosphate ester may be present in an amount from about 5% to about 40% by weight of the B-side. The third phosphate ester, if present, may be present in an amount from about 0.5% to about 90% by weight of the B-side. The third phosphate ester may be present in an amount from about 10% to about 70% by weight of the B-side. The third phosphate ester may be present in an amount of about 20% to about 65% by weight of the B-side.

The B-side may include phosphoric acid. The phosphoric acid may be ortho-phosphoric acid, polyphosphoric acid, or both. The phosphoric acid may be polyphosphoric acid. The phosphoric acid may be free acid in the one or more phosphate esters, added independently from the one or more phosphate esters, or both. The addition of phosphoric acid to the B-side may result in increased expansion (e.g., foaming) of the resulting reaction product. The addition of phosphoric acid to the B-side may increase the reactivity of the two-part system to help maintain desired levels of expansion, curing, or both when temperatures are below 23° C.

The independently added phosphoric acid, if present, may be in aqueous solution in the amount of 85% or more, or even 95% or more (i.e., “reagent grade”). The independently added phosphoric acid may be present in an amount from about 0.1% to about 30% by weight of the B-side. The independently added phosphoric acid may be present in an amount from about 2% to about 6% by weight of the B-side. The independently added phosphoric acid may be present in an amount of about 4% by weight of the B-side.

The one or more phosphate esters produced from the reaction of phosphoric acid and one or more epoxide group containing components, may include free acid. The one or more phosphate esters may have about 1% or more free acid, about 3% or more free acid, about 5% or more free acid, about 15% or less free acid, about 13% or less free acid, or even about 11% or less free acid.

The one or more phosphate esters produced from the reaction of anhydrous phosphoric moieties such as phosphoric anhydride, phosphoryl chloride, or polyphosphoric acid and one or more alcohol group containing components, may include free acid. The one or more phosphate esters may have about 1% or more free acid, about 3% or more free acid, about 5% or more free acid, about 15% or less free acid, about 13% or less free acid, or even about 11% or less free acid.

The two-component system, upon addition of the A-side and the B-side, may foam as a result of a reaction of metal carbonate or metal bicarbonate and an acid, generating the release of gas (e.g., carbon dioxide) to serve as chemical blowing agent. Such a reaction mechanism is described in U.S. Pat. No. 5,648,401, incorporated by reference herein for all purposes.

The curing, foaming, or both may occur at a temperature of about 50° C. or less, 40° C. or less, about 30° C. or less, about 20° C. or less, or about 0° C. or less. The curing, foaming, or both may occur at a temperature of about 0° C. or more, about 10° C. or more, or even about 20° C. or more. The curing, foaming, or both may occur at a temperature from about 10° C. to about 50° C., or even more. The curing, foaming, or both may occur at a temperature of about 10° C. The curing, foaming, or both may occur at room temperature (e.g., at a temperature of about 15° C. to about 25° C.). The curing, foaming, or both may occur at a temperature of about 23° C. The curing and foaming may occur at different temperatures or at substantially the same temperature. As previously stated, the system described herein may be free of any foaming. The system described herein may include only minimal foaming (e.g., 0.5% to about 2% volumetric expansion).

The present teachings contemplate a relatively fast curing time, foaming time, or both as compared to other cure agents or cure systems that occur without the addition of a stimulus (e.g., at room temperature). The cure time of the reaction product may be 75 minutes or less, 50 minutes or less, 30 minutes or less, 20 minutes or less, 2 minutes or more, 8 minutes or more, or even 16 minutes or more. The cure time of the resulting reaction product may be from about 5 minutes to about 20 minutes. The cure time of the resulting reaction product may be about 10 minutes. The cure time of the resulting reaction product may be about 7 minutes. The cure time of the resulting reaction product may be about 5 minutes. The curing and foaming may occur at different times or at substantially the same time.

Foaming, if present, may begin before complete cure of the resulting reaction product. The foaming time (i.e., the time frame within which the two-part system actively foams) of the reaction product may be 30 minutes or less or even 20 minutes or less. The foaming time of the reaction product may be from about 1 minute to about 10 minutes. The foaming time of the reaction product may be about 5 minutes. The foaming time of the reaction product may be about 7 minutes.

The rate of cure, the degree of crosslinking, or both may be a function of the functionality of the two-part system (A-side and B-side). A higher functionality (i.e., number of functional groups on one or more polymerizable components) may be desired for a two-part system having pre-polymerized components that are shorter in polymer length (i.e., lower viscosity); whereby the lack of structural backbone resulting from shorter polymers is compensated by a higher degree of crosslinking. A lower functionality may be desired for a two-part system having pre-polymerized components that are longer in length (i.e., higher viscosity); whereby the presence of more structural backbone resulting from longer polymers precludes the need for high functionality.

The B-side functionality may at least partially be reduced by the reaction of metal carbonate in the A-side with phosphoric acid and the phosphate esters. As a result, the functionality of the B-side may be reduced in the in-situ reaction mixture. The A-side may include components with increased functionality in order to compensate for a reduced functionality of the B-side. The A-side may be formulated with increased functionality by using reactive ingredients with functionality higher than two.

The two-part system may include one or more additives. The one or more additives may include one or more toughening agents, metal carbonates, reinforcing fibers or other reinforcing particulates, hydrophobic silica, tabular alumina, or any combination thereof.

The two-part system may include one or more minerals. The one or more minerals (i.e., “mineral reinforcement”) may function to structurally reinforce the reaction product. The one or more minerals may improve tensile strength, the flexural strength, or both of the reaction product. The one or more minerals may be any suitable silicate minerals including but not limited to inosilicates (e.g., Wollastonite) and phyllosilicates (e.g., Kaolinite, Vermiculite, Talc, Muscovite, etc.). The characteristic external shape of an individual crystal or crystal group of the one or more minerals may be acicular or needle-like. The median particle size of the one or more minerals may be from about 10 microns to about 20 microns. The median particle size may be from about 12 microns to about 18 microns.

The one or more minerals may include Wollastonite (CaSiO3). The Wollastonite may be relatively pure (i.e., less than 2% by weight of impurities such as other metal oxides). The Wollastonite may contain impurities including one or more oxides of iron, magnesium, manganese, aluminum, potassium, sodium, or strontium substituting for calcium in the mineral structure. Examples of suitable Wollastonite may be that sold under the trade names NYGLOS® 12 and NYGLOS® 8 commercially available from NYCO Minerals Inc. (Willsboro, NY).

The one or more minerals may be present as part of the A-side, the B-side, or both. The Wollastonite may be present in an amount from about 1% to about 18% by weight of the A-side, B-side, or both the A-side and B-side in combination. The Wollastonite may be present in an amount from about 3% to about 7% by weight of the A-side, B-side, or both the A-side and B-side in combination. The Wollastonite may be present in an amount of about 4% by weight of the A-side, B-side, or both the A-side and B-side in combination.

The two-part system may include one or more reinforcing fibers. The reinforcing fiber may function to structurally reinforce the reaction product. The one or more reinforcing fibers may improve tensile strength, flexural strength, or both of the reaction product. The one or more reinforcing fibers may be present in the A-side, the B-side, or both. The one or more reinforcing fibers may be dispersed homogenously within the A-side, the B-side, or both. The one or more reinforcing fibers may comprise polymeric fibers, glass fibers (i.e., fiberglass), or both. Polymeric fibers may include nylon, polyamide, polyester, polypropylene, polyethylene, polytetrafluoroethylene, aramid fibers (e.g., Kevlar®), the like, or any combination thereof. The glass fibers may include alumino-borosilicate glass (“E-glass”), alkali-lime glass (“A-glass” or “C-glass”), electrical/chemical resistance glass (“E-CR-glass”), borosilicate glass (“D-glass”), alumino-silicate glass (“R-glass” or “S-glass”), or any combination thereof. The reinforcing fiber may be chopped fiber. The reinforcing fiber may be a chopped length of about 0.1 cm or more, about 0.3 cm or more, or even about 0.6 cm or more. The reinforcing fiber may be a chopped length of about 2.0 cm or less, about 1.5 cm or less, or even about 1.0 cm or less. Examples of suitable fiberglass may be chopped strands commercially available from Jushi USA (Columbia, SC).

The reinforcing fiber may be present in the amount from about 0.01% by weight to about 15% by weight of the A-side, B-side, or both the A-side and B-side in combination. The reinforcing fiber may be present in the amount from about 1% by weight to about 10% by weight A-side, B-side, or both the A-side and B-side in combination. The reinforcing fiber may be present in the amount of about 3% by weight A-side, B-side, or both the A-side and B-side in combination.

The two-part system may include hydrophobic silica. The hydrophobic silica may function to control viscosity (e.g., thicken), control thixotropy, boost hydrophobia, or a combination thereof. The hydrophobic silica may be fumed silica. The hydrophobic silica may be surface treated. For example, the hydrophobic silica may be fumed silica surface-treated with polydimethylsiloxane (hereinafter “PDMS”) or hexamethyldisilazane (hereinafter “HMIDZ”). The hydrophobic silica may be present as part of the A-side, the B-side, or both. Examples of suitable hydrophobic silica may be that sold under the trade name AEROSIL® R 202 commercially available from Evonik Corporation (Parsippany, NJ); and those sold under the trade name CAB—O-SIL® TS-530 and TS-720 commercially available from Cabot Corporation (Boston, MA).

The hydrophobic silica may be present in an amount of about 0.25% to about 15% by weight of the A-side, B-side, or both the A-side and B-side in combination. The hydrophobic silica may be present in an amount of about 0.1% to about 4% by weight of the A-side, B-side, or both the A-side and B-side in combination. The hydrophobic silica may be present in an amount from about 1% to about 3% by weight of the A-side, B-side, or both the A-side and B-side in combination. The hydrophobic silica may be present in an amount from about 1% by weight of the A-side. The hydrophobic silica may be present in an amount from about 1% to about 3% by weight of the B-Side. The ratio of hydrophobic silica in the A-side to the B-side may be from about 1:3 to about 3:1. The ratio of hydrophobic silica in the A-side to the B-side may be about 1:2 to about 2:1.

The two-part system may include tabular alumina. The tabular alumina may function to impart hardness, resistance to thermal shock, resistance to mechanical shock, high heat capacity, high electrical resistance, or any combination thereof, to the reaction product. The tabular alumina may be present in the A-side, the B-side, or both. The tabular alumina may be alpha alumina converted to its corundum form (i.e., crystalline aluminum oxide) and sintered and may be provided as graded granules or powders. The tabular alumina may be graded (i.e., separated by size) from about 44 microns to about 4760 microns. The tabular alumina may be graded to about 44 microns.

The tabular alumina may be present in an amount from about 3% to about 15% by weight A-side, B-side, or both the A-side and B-side in combination. The tabular alumina may be present in an amount from about 4% to about 12% by weight A-side, B-side, or both the A-side and B-side in combination. The tabular alumina may be present in an amount of about 5% by weight A-side. The tabular alumina may be present in an amount of about 10% by weight A-side.

The two-part system may include one or more functional additives for improving one or more various properties of the composition. Examples of suitable functional additives may include antioxidants, antiozonants, ultraviolet absorbers, antistatic agents, colorants, coupling agents, curing agents, flame retardants, blowing agents, heat stabilizers, impact modifiers, lubricants, plasticizers, preservatives, processing aids, stabilizers, the like, and any combination thereof.

The viscosity of the A-side, the B-side, or both may be high enough at about 23° C. in order to preclude the two-part system from undesirably flowing into areas adjacent the dispensed bead upon dispensing the two-part system on a workpiece or to control flow (i.e., permit a desired amount of flow) into areas adjacent the dispensed bead upon dispensing the two-part system. The viscosity of the A-side, B-side, or both, needed to preclude undesirable flow or control flow may depend on the size of the bead dispensed. For example, the thicker the bead of the two-part system dispensed, the higher the viscosity needed to preclude unintended flow or control flow. The viscosity of the A-side at 23° C. may be from about 20,000 cP to about 50,000 cP or even from about 35,000 cP to about 45,000 cP. The viscosity of the A-side and B-side at 23° C. may be from about 250,000 cP to about 400,000 cP. The viscosity of the A-side at 10° C. may be from about 280,000 cP to about 350,000 cP or even from about 300,000 cP to about 325,000 cP. The viscosity of the B-side at 23° C. may be from about 20,000 cP to about 50,000 cP or even from about 35,000 cP to about 45,000 cP. The viscosity of the B-side at 10° C. may be from about 130,000 cP to about 220,000 cP or even from about 175,000 cP to about 195,000 cP.

The two-part system may expand, upon mixing the A-side and B-side, more than about 10%, more than about 50%, more than about 100%, less than about 300%, less than about 200%, or even less than about 150% the two-part system's original volume. The two-part system may expand from about 50% to about 100% the two-part system's original volume.

The two-part system may be free of curing agents (i.e., typical curing agents), curing accelerators, or both. Typical curing agents include lewis bases (i.e., anionic catalysts), lewis acids (i.e., cationic catalysts), UV catalysts, amines, anhydrides, phenols, thiols, or any combination thereof. In place of the aforementioned curing agents, the two-part system may cure upon a polymerization reaction, catalyzed by phosphoric acid, between phosphate esters and epoxide groups, hydroxy groups, or both. The two-part system may be both cured and caused to expand by the chemical interaction between phosphate ester and a metal carbonate. It has been found that utilizing the cure and expansion system of the present disclosure may reduce the complexity of formulations by reducing the number of overall components (i.e., curing agents, curing accelerators, and blowing agents); however, the achievement of a desired expansion and time to cure is made more challenging to optimize.

Table 1 shows examples of formulations. These are examples in which different amounts of ingredients such as DER 732, epoxidized linseed oil, Silmer EPC-Di50, and Portland Cement in the A-side and P₂O₅ in B-side are studied.

TABLE 1

| | UW- | UW- | UW- | UW- | UW- |
|---|---|---|---|---|---|
| | 69 | 69a | 69b | 70 | 73 |
| A-side | | | | | |
| Epoxy phenol novolac | 45 | 44.3 | 43.4 | 48 | 46 |
| resin | | | | | |
| Core shell toughening | 13 | 14.6 | 12.4 | 13.5 | 13 |
| agent | | | | | |
| Epoxy resin dissolved | 8.5 | 8.4 | 8.2 | 9 | 8.5 |
| in xylene | | | | | |
| Liquid epoxy resin | 20 | 19.6 | 19.2 | 15 | 15 |
| Multi-functional epoxy | 0.4 | 0.4 | 0.4 | 0.5 | 0.4 |
| resin | | | | | |
| Ultra-fine calcium | 0.1 | 0.1 | 0.1 | 0.1 | 0.1 |
| carbonate | | | | | |
| Medium fine calcium | 0.2 | 0.2 | 0.2 | 0.2 | 0.2 |
| carbonate | | | | | |
| Fumed silica | 0.8 | 0.8 | 0.8 | 0.9 | 0.9 |
| Epoxidized Linseed Oil | 2 | 2 | 1.9 | 3 | 6 |
| Wollastonite | 10 | 9.6 | 9.4 | 10 | 10 |
| Silicone prepolymer | 0 | 2 | 2 | 0 | 0 |
| Portland Cement | 0 | 0 | 2 | 0 | 0 |
| Total | 100.0 | 100.0 | 100.0 | 100.0 | 100.0 |
| B-side | | | | | |
| PE-01 (phosphate ester) | 22 | 22 | 22 | 21 | 21 |
| PE-03 (phosphate ester) | 58 | 58 | 58 | 54 | 54 |
| Adducted carboxyl | 1.5 | 1.5 | 1.5 | 1.5 | 1.5 |
| terminated polymer | | | | | |
| Fumed silica | 2.5 | 2.5 | 2.5 | 2.5 | 2.5 |
| Wollastonite | 9 | 9 | 9 | 8.5 | 8.5 |
| P₂O₅ | 0 | 0 | 0 | 6 | 6 |
| Phosphoric Acid (85%) | 7 | 7 | 7 | 6.5 | 6.5 |
| Total | 100.0 | 100.0 | 100.0 | 100.0 | 100.0 |

Table 2 illustrates some mechanical testing results for the formulations shown in Table 1. Dry samples are prepared at ambient temperature and pressure. The underwater samples are prepared underwater and stored under water prior to testing. The lap-shear samples are prepared when both substrates were under the water surface line; material is purged on one substrate and the second substrate is placed on top of that. They are removed from water a day prior to testing and kept at ambient condition and then tested in conditions similar to dry samples. Lap shear testing is performed on 2 mm thickness Al 6061 where the bond line is 1 mm and overlap is 25.4 mm in 25.4 mm. UW-69 shows better lap shear strength in dry condition, the UW-70 shows better lap shear strength underwater, and UW-73 shows similar lap shear strength in dry condition and underwater. Samples UW-70 and 73 cure much faster and are more rigid than sample UW-69. The cure time is shorter mainly due to the presence of P₂O₅ in the B-side and the presence of more Epoxidized Linseed Oil in the A-side. The addition of P₂O₅ to the B-side and the increase of Epoxidized Linseed Oil in the A-side both increase the underwater cured lap shear strength compared to formulations without P₂O₅ and with less Epoxidized Linseed Oil. Peel load is higher for all three samples when cured underwater as compared to dry cure condition.

TABLE 2

| Test | UW-69 | UW-70 | UW-73 |
|---|---|---|---|
| Dry Lap Shear Peak Stress (MPa)* | 18.6 | 8.8 | 14.1 |
| Underwater cured Lap Shear Peak Stress | 9.1 | 16.9 | 12.8 |
| (MPa)* | | | |
| Dry Compressive Modulus (MPa) | 593.8 | 1340.7 | 1221.9 |
| Dry Compressive Stress at Yield (MPa) | 16.0 | 63.7 | 55.1 |
| Dry Expansion (%) | 5 | 0-5 | 0-5 |
| Underwater Cured Compressive Modulus | 720.3 | 248.4 | 150.5 |
| (MPa) | | | |
| Underwater Cured Stress at Yield (MPa) | 30.0 | 8.0 | 4.0 |
| Underwater Cured Expansion (%) | 0-5 | 10-20 | 15-20 |
| Dry Tensile Peak Stress (MPa) | 13.3 | 32.7 | 30.1 |
| Dry Tensile Elongation (%) | 10-20 | 1-5 | 1-5 |
| Dry Peel Load (N/mm) | 2.4 | 2.0 | 2.4 |
| Underwater Cured Peel Load (N/mm) | 4.0 | 3.1 | 3.1 |

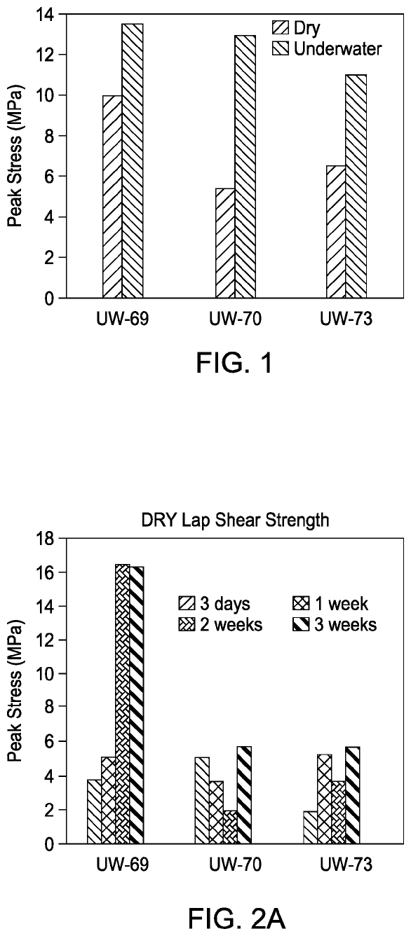

FIG. 1 shows a stainless steel 304 lap shear strength for UW-69, UW-70 and UW-73 formulations (from Table 1) in dry and underwater cure conditions. Lap shear testing is performed based on methods specified in ASTM D1002-10. Lap shear is performed on 2 mm thickness stainless steel 304 where the bond line is 1 mm and overlap is 25.4 mm by 25.4 mm. The underwater cure results are better than the dry cure results for all three samples. UW-69 has higher results for both dry cure and underwater cure than UW-70 and UW-73.

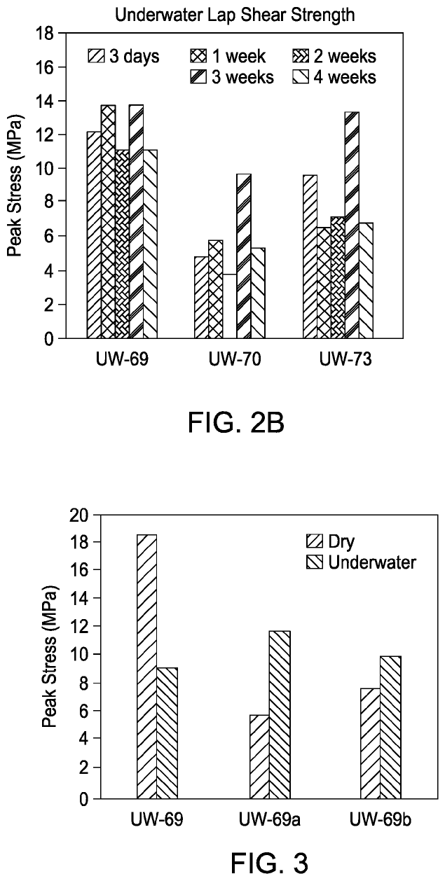

FIGS. 2A and 2B show the aging effect on dry (2A) and underwater (2B) cured samples before testing. Lap shear testing is performed based on methods specified in ASTM D1002-10. Lap shear is performed on 2 mm thickness Al 6061 where bond line is 1 mm and overlap is 25.4 mm by 25.4 mm. For dry samples, the specimens are made and then stored for 3 days, 1 week, 2 weeks, or 3 weeks before being tested. Underwater specimens are prepared under the water and then kept underwater for 3 days, 1 week, 2 weeks, 3 weeks, or 4 weeks. They are removed and kept at ambient overnight before being tested. All three formulations see an increase in dry cure results over the course of three weeks, but UW-69 sees the greatest increase. For underwater cure, UW-70 sees an increase in results over four weeks. UW-69 retains roughly 90% of its peak stress over four weeks while UW-73 retains around 70%.

FIG. 3. shows lap shear strength for samples UW-69, UW-69a, and UW-69b, both in dry and underwater condition. Adding a small amount of Silmer EPC-Di50 (sample UW-69a) improves the underwater results. However, it decreases the dry lap shear strength. Adding small amount of Portland Cement (sample UW-69b) improves the dry cured lap shear but reduces the underwater cured lap shear as compared to UW-69a. Lap shear testing is performed based on methods specified in ASTM D1002-10. Lap shear is performed on 2 mm thickness Al 6061 where the bond line is 1 mm and overlap is 25.4 mm by 25.4 mm.

Table 3 shows lap shear strength for samples UW-69, UW-70, and UW-73 cured in saltwater and in ice water conditions respectively. The saltwater samples are dispensed and stored in water/3.5% NaCl by weight for a week prior to testing. The ice water specimens are dispensed in ice water and then stored in 35° F. fridge for a week before being tested. Lap shear is performed on 2 mm thickness Al 6061 where bond line is 1 mm and overlap is 25.4 mm by 25.4 mm.

TABLE 3

| Test | UW-69 | UW-70 | UW-73 |
|---|---|---|---|
| Saltwater Lap Shear Peak Stress (MPa) | 10.62 | 6.04 | 6.50 |
| Ice Water Lap Shear Peak Stress (MPa) | 4.97 | 3.18 | 4.20 |

The two-part system may be provided as side-by-side cartridges, pails, or drums. The two-part system may be mixed prior to dispensing on a workpiece. The two-part system may be applied to a workpiece via any suitable dispenser by which the two-part system is mixed before dispensing on the workpiece. For example, the two-part system may be dispensed onto a workpiece via a static mixer that is configured to deliver a mixed curable composition that has a suitable mix ratio, as described herein.

The two-part system may be utilized in any location where underwater repair may be necessary. The two-part system may be utilized in any location where contact with water is frequent. The two-part system may be utilized in boating applications. The system can be utilized for diverse applications such as various industrial manufacturing operations and for various construction purposes.

The present teachings provide a method that may comprise providing a two-part system, the two-part system including an A-side (i.e., first component) and a B-side (i.e., second component). The A-side including one or more epoxy resins and the B-side including one or more phosphate esters and optionally phosphoric acid. The A-side and the B-side may be mixed to form a curable composition. The method may include a step of curing the curable composition of the at a temperature of less than 50° C., thereby forming a reaction product. The method may comprise a step of mixing the first component and the second component to form a reaction prod. The method may comprise a step of wherein the reaction product of the first component and the second component cures at a temperature of less than 50° C. The method may be employed with an A-side that includes one or more epoxy resins, a metal carbonate, or both. The method may be employed with a B-side that includes one or more phosphate esters, phosphoric acid, or both. The method may be employed with and A-side, a B-side, or both having one or more additives.

Use of the teachings herein may result in a material that exhibits sufficient flame retardancy to meet one or more of the requirements for demonstrating flame retardancy (e.g., to meet vertical burn and/or smoke density requirements (or some other requirement) as set forth in 14 C.F.R. § 25.853 and 14 C.F.R. § 25.856 (the United States Code of Federal Regulations for compartment interiors, including but not limited to 14 C.F.R. § 25.853(a), and the referenced Appendix F and procedures referenced therein), all of which are incorporated by reference for all purposes.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1: A two-part system comprising:
a) a first component including
one or more epoxy resins; and
an epoxy functional material having an epoxy functionality of greater than 4 and viscosity at 25° C. of less than 850 cps determined according to ASTM D-445;
b) a second component including one or more phosphate esters;
wherein upon mixing the first component with the second component at room temperature, a composition is formed
(i) having a cured underwater lap shear at peak stress of at least 7 MPa; and/or
(ii) comprising:
(A) 40 to 85 wt.-% of the one or more epoxy resins relative to the weight of the first component, wherein the one or more epoxy resins comprise liquid epoxy resin, epoxy phenol novolac resin, epoxy resin dissolved in xylene, or combinations thereof;
(B) 0.5 to 10 wt.-% of the epoxy functional material relative to the weight of the first component, wherein the epoxy functional material comprises epoxidized linseed oil;
(C) 50 to 90 wt.-% of the one or more phosphate esters relative to the weight of the second component; and
(D) one or more additives in both the first and second component.

2: The two-part system of claim 1, wherein upon mixing the first component and second component, the composition cures at a temperature of about 0° C. to about 50° C.

3: The two-part system of claim 1, wherein the first component includes a cement.

4: The two-part system of claim 2, wherein the first component includes silicone prepolymer.

5: The two-part system of claim 1, wherein the one or more phosphate esters includes a phosphate ester derived from cashew nutshell liquid (CNSL), 2-ethylhexyl qlycidyl ether, phenyl qlycidyl ether, an epoxidized para-tertiary butyl phenol, nonyl phenol ethoxylated phosphate ester, or some combination thereof.

6-9. (canceled)

10: The two-part system of claim 1, wherein the epoxy functional material is an epoxidized linseed oil.

11: The two-part system of claim 10, wherein the composition includes one or more additives selected from a core-shell polymer, metal carbonate, minerals, reinforcing fiber, hydrophobic silica, a monomer, tabular alumina, or any combination thereof.

12: The two-part system of claim 10, including calcium carbonate present in an amount from about 0.01% to about 10% by weight, relative to the total weight of the two-part system.

13: The two-part system of claim 1, including an ultrafine calcium carbonate (about 1 micron mean particle size), a fine calcium carbonate (about 4 micron mean particle size), a medium fine calcium carbonate (about 22 micron mean particle size), or any combination thereof.

14: The two-part system of any of claim 1, wherein one or both of the first and second component includes Wollastonite.

15: The two-part system of claim 1, wherein one or both of the first and second component include fumed silica.

16: The two-part system of claim 2, wherein the second component includes P₂O₅, polyphosphoric acid, or some combination thereof.

17: The two-part system of claim 16, wherein the second component includes one or more of tabular alumina, reinforcing fiber, hydrophobic silica, minerals, a monomer, phosphoric acid, or any combination thereof.

18: The two-part system of claim 10, wherein the one or more epoxy resins or epoxy functionalized resins include one or more liquid epoxy resins, one or more epoxy phenol novolac resins, one or more aliphatic multifunctional epoxy resins, one or more phenoxy resins, one or more silane modified epoxy resins, or any combination thereof.

19: The two-part system of claim 1, including one or more epoxy phenol novolac resins with a functionality from about 2 to about 3; an epoxy phenol novolac resin with a functionality from about 3 to about 4; or both.

20: The two-part system of claim 19, including one or more epoxy phenol novolac resins present in an amount from about 30% to about 70% by weight, preferably about 35% to about 55% by weight, relative to the total weight of the first component.

21-22. (canceled)

23: The two-part system of claim 1, wherein the composition cures at a temperature of about 15° C. to about 25° C.

24: The two-part system of claim 23, wherein the composition cures in water.

25: The two-part system of claim 1, wherein other than the phosphate esters, the two-part system is substantially free of curing agents, latent curing accelerators, or both.

26-33. (canceled)

34: A two-component system comprising:
(A) liquid epoxy resin and epoxy resin dissolved xylene in a first component;
(B) an epoxy functional material comprising epoxidized linseed oil in the first component;
(C) one or more phosphate esters in a second component;
(D) P₂O₅, polyphosphoric acid, or some combination thereof in the second component.
